(19) United States
(12) Patent Application Publication
(10) Pub. No.: US 2004/0177224 A1
(43) Pub. Date: Sep. 9, 2004

(54) Local memory with ownership that is transferrable between neighboring processors

(76) Inventors: Patrick Devaney, Haverhill, MA (US); David M. Keaton, Boulder, CO (US); Katsumi Murai, Moriguchi-City (JP)

Correspondence Address: RATNERPRESTIA, P O BOX 980, VALLEY FORGE, PA, 19482-0980, US

(21) Appl. No.: 10/384,198

(22) Filed: Mar. 7, 2003

(51) Int. Cl. G06F 12/00

(52) U.S. Cl. 711/148; 711/151

(57) ABSTRACT

A multiprocessor system for concurrently executing multiple tasks includes first and second processors, each configured to execute at least one task and a local memory physically disposed externally of, and concurrently accessible by the first and second processors. An operating system assigns: (a) a first task to the first processor and a second task to the second processor, the first and second tasks having respective execution resource requirements, (b) a first portion of the local memory to the first processor, and (c) a second portion of the local memory to the second processor. The operating system is configured to initially adjust the first and second portions of the local memory based on the respective execution resource requirements. Portions of the local memory assigned to be shared by the first and second processors may be cooperatively accessed by each of the processors without intervention by the operating system.

### TECHNICAL FIELD

The present invention relates, in general, to multiprocessors and, more specifically, to a level one memory that is architected directly into two neighboring processors, with both processors capable of owning the memory.

### BACKGROUND OF THE INVENTION

Chip multi-processor (CMP) architectures are usually homogeneous, that is, all processors have identical resources. This saves design time and reduces target complexity for software. But, applications come with a variety of execution resource needs. The inflexibility (or quantization) of execution resources per processor may cause resource mismatches. For example, an application task may require two CPUs to meet performance requirements, but may need very few registers. In a homogeneous architecture, the registers may be wasted. On the other hand, a task may need only one CPU for performance, but may require more registers than one CPU possesses. In that case, extra CPUs must be assigned to the task merely to provide registers. The CPU resources are, therefore, wasted.

Memory devices are often shared by multiple processors in order to reduce the number of system components on a chip. Arbitration circuits are generally included in such systems to prevent collisions between multiple processors simultaneously attempting to access the same memory device.

In shared memory, one processor may write data into a memory location and another processor may read the data. In order to prevent collision, access to the shared memory must be controlled. Shared memory transfers typically require a high hand-shaking overhead compared to a single data transfer. As a result, processors connected via shared memory are usually categorized as loosely-coupled systems.

There are many memory sharing methods that use tokens, semaphores, etc. to grant ownership to a processor. All these methods treat the memory as a global resource which multiple processors compete to own. U.S. Pat. No. 6,108,693 issued Aug. 22, 2000, discloses a multiprocessor system having a transmitting processor and a receiving processor. In response to a transmission request, the transmitting processor selects one of two communication buffers of a shared memory. The transmitting processor changes the selected buffer to a write-disabled state in order to inhibit writing by other processors. The transmitting processor then writes to the selected buffer and notifies the receiving processor of completion of writing. In response to a reception request, the receiving processor selects one of the two communication buffers of the shared memory. The receiving processor then waits until the communication buffer attains a read-enabled state. After reading the data, the receiving processor changes the state of the buffer to a write-enabled state. In this manner, data may be shared between the processors via the two communication buffers.

U.S. Pat. No. 5,907,862, issued May 25, 1999, describes an arbitrated-access method to a shared, single-port, random access memory (RAM). An access control circuit is provided which includes a control register with a first storage element corresponding to a first processor and a second storage element corresponding to a second processor. The access control circuit utilizes access request bits stored in the first and second storage elements to generate a select signal that is applied to the select signal input lines of a group of multiplexers. The multiplexers select either the first processor or second processor control, address and data signal lines for connection to the single-port RAM. The access control circuit is configured such that the first processor to successfully set the access request bit in its corresponding storage element is granted temporary exclusive access to the RAM. The storage elements are interconnected such that the output of a given element drives a reset input of the other element. Once a given processor sets its access request bit and is thereby granted access to the shared RAM, the storage element interconnection prevents the other processor from setting its access request bit until the given processor relinquishes control of the RAM.

U.S. Pat. No. 6,108,756, issued Aug. 22, 2000, discloses memory banks with left and right ports for communicating with left and right processors. Semaphore logic is used to generate bank access grant signals on a first received basis in response to bank access requests from the left and right processors, and port coupling circuitry couples selected memory banks to the left and right ports in response to bank access grant signals. Included in the memory device are mail-box registers. The left and right processors use the mail-box registers to send messages to each other without waiting. Interrupt generating circuitry generates interrupts to notify the left and right processors that their bank access requests have been granted, and a message has been written into one of the mail-box registers. These mail-box registers are not part of a register file of any of the processors.

U.S. Pat. No. 5,530,817, issued Jun. 25, 1996, discloses multiple processors, each executing a portion of a very large instruction word (VLIW). Each processor contains independent register files for executing portions of the VLIW. Each processor may write data directly into another processor's register file and this written data may become part of an operand for the other processor. Such method provides tight coupling between the processors. While this coupling is very fast, it may complicate scheduling for the compiler.

### SUMMARY OF THE INVENTION

To meet the needs of flexible resource assignment, shared memory, and other needs, and in view of its purposes, the present invention provides a multiprocessor system for concurrently executing multiple tasks including first and second processors, each configured to execute at least one task, and a local memory physically disposed externally of, and concurrently accessible by, the first and second processors. Also included is an operating system, responsive to compiler-generated execution resource requirements for tasks, for assigning: (a) a first task to the first processor and a second task to the second processor, the first and second tasks having respective execution resource requirements, (b) a first portion of the local memory to the first processor, and (c) a second portion of the local memory to the second processor. The operating system is configured to initially adjust the first and second portions of the external local memory based on the respective execution resource requirements.

In an embodiment of the invention, the first and second processors each includes at least one page translation table (PTT) for granting or preventing access to the first and second portions of the local memory. The PTT includes a physical location in the local memory, the physical location corresponding to a virtual location provided by a task instruction, and a protection bit for granting or preventing access to the physical location. The first and second processors each includes multiple read ports to the PTTs for concurrently granting access to as many as two source operands and a destination operand located in the external local memory.

Owner flags are included which are stored in a register. The owner flags are initially assigned by the operating system to the first and second portions of the local memory. A first owner flag initially grants ownership of the first portion of the local memory to the first processor and a second owner flag initially grants ownership of the second portion of the local memory to the second processor. The first owner flag, for example, grants ownership of the first portion of the local memory to the first processor at execution startup of the first task. The first processor may include a giveup page command for toggling the first owner flag in the register, where the giveup page command gives up ownership of the first portion of the local memory by the first processor and grants ownership of the first portion of the local memory to the second processor.

In an embodiment of the invention, the local memory is physically disposed at substantially equal distances between the first and second processors, and different pages of the local memory are concurrently accessible by the first and second processors. Data requested from a LM by the CPU in one cycle is available to be used as an operand to a CPU operation in the following cycle.

The invention includes a method used by a multiprocessor system that has a compiler, an operating system, first and second processors for executing first and second tasks, respectively, and an external local memory that has pages physically disposed between the processors. The method assigns at least one page of the local memory to at least one of the processors. The method includes:

(a) determining a number of pages of the external local memory used to execute each of the first and second tasks;

(b) assigning, initially, a common page in the local memory to the first and second processors;

(c) assigning, initially, ownership of the common page, to the first processor;

(d) accessing the common page during execution of the first task;

(e) giving up ownership of the common page, after completion of the first by the first processor; and

(f) granting ownership of the common page, directly to the second processor, free-of intervention from the operating system.

In an embodiment of the invention, the method includes setting an owner flag for initially granting exclusive ownership of the common page to the first processor. The owner flag is set at execution startup of the first task. The method includes issuing a giveup page command for toggling ownership of the common page from the first processor to the second processor. The step of accessing the common page by the first processor includes accessing as many as two source operands and a destination operand on that page in a single clock cycle.

In another embodiment, the invention includes a method of a multiprocessor system having a scalable processor architecture (SPARC) and first and second processors concurrently executing a SPARC instruction set. The method accesses a local memory, in which the local memory is externally located between the first and second processors. The method includes the steps of: (a) assigning, by an operating system, a first task to the first processor and a second task to the second processor; (b) assigning, by the operating system, a first portion of the externally located local memory to the first processor, based on execution resource requirements for executing the first task; and (c) preventing, by the operating system, access by the second processor to the first portion of the externally located local memory assigned to the first processor.

The method of step (b) in the SPARC architecture further includes writing in an operating system privileged ancillary state register (ASR) a physical location of the first portion of the local memory; and writing, in the ASR, a validity bit, corresponding to the physical location of the first portion of the local memory for allowing access by the first processor. The method also includes writing in a different, non-privileged ASR an owner flag granting current ownership to the first processor of the first portion of the local memory. The method further includes giving up ownership of the first portion of the local memory by the first processor, free-of intervention from the operating system; and allowing access from the second processor to the first portion of the local memory, after giving up ownership in step (d), free-of intervention from the operating system.

It is understood that the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a block diagram of a central processing unit (CPU), showing a left data path processor and a right data path processor incorporating an embodiment of the invention;

FIG. 2 is a block diagram of the CPU of FIG. 1 showing in detail the left data path processor and the right data path processor, each processor communicating with a register file, a local memory, a first-in-first-out (FIFO) system and a main memory, in accordance with an embodiment of the invention;

FIG. 3 is a block diagram of a multiprocessor system including multiple CPUs of FIG. 1 showing a processor core (left and right data path processors) communicating with left and right external local memories, a main memory and a FIFO system, in accordance with an embodiment of the invention;

FIG. 4 is a block diagram of a multiprocessor system showing a level-one local memory including pages being shared by a left CPU and a right CPU, in accordance with an embodiment of the invention;

FIG. 5A is a block diagram of a multiprocessor system showing local memory banks, in which each memory bank is disposed physically between a CPU to its left and a CPU to its right, in accordance with an embodiment of the invention;

FIG. 5B is a global table of local memory page usage, residing in main memory and managed by an operating system, in accordance with an embodiment of the invention;

FIG. 6A is a representation of a page translation table (PTT) of a local memory showing eight data fields, each data field having four bits per page of the local memory, which are physically implemented in a 32 bit register, in accordance with an embodiment of the invention;

FIG. 6B is a representation of a set of ownership flags (left/right flags), indicating ownership of pages in a local memory by a CPU, which is physically implemented in another 32 bit register, in accordance with an embodiment of the invention;

FIG. 7 is a flow diagram of a method in which the operating system sets up a task for execution by a CPU and initializes the data fields of a PTT of a local memory, in accordance with an embodiment of the invention;

FIG. 8 is a flow diagram of a verification method performed by the PTT hardware before permitting a CPU to access a page in local memory, in accordance with an embodiment of the invention;

FIG. 9 is a flow diagram of a method of transferring ownership of a shared page in local memory between two cooperating tasks, respectively executed by different CPUs, in accordance with an embodiment of the invention; and

FIG. 10 is a flow diagram of a method in which a task gives up ownership of a shared page in local memory and allows another task to obtain ownership of the same shared page, in accordance with an embodiment of the invention.

### DETAILED DESCRIPTION OF THE INVENTION

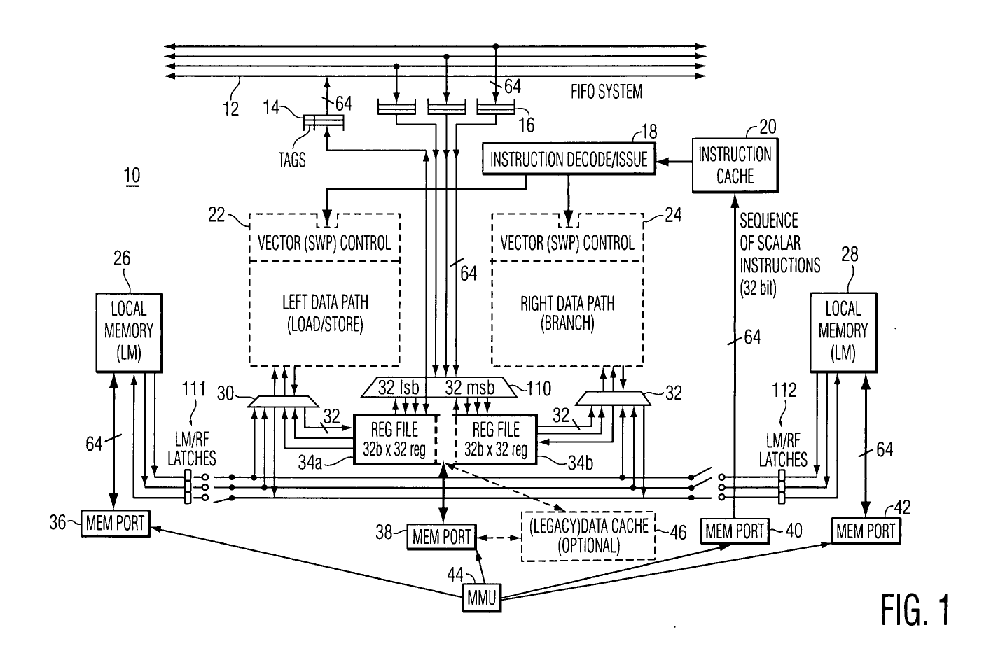

Referring to FIG. 1, there is shown a block diagram of a central processing unit (CPU), generally designated as 10. CPU 10 is a two-issue-super-scalar (2i-SS) instruction processor-core capable of executing multiple scalar instructions simultaneously or executing one vector instruction. A left data path processor, generally designated as 22, and a right data path processor, generally designated as 24, receive scalar or vector instructions from instruction decoder 18.

Instruction cache 20 stores read-out instructions, received from memory port 40 (accessing main memory), and provides them to instruction decoder 18. The instructions are decoded by decoder 18, which generates signals for the execution of each instruction, for example signals for controlling sub-word parallelism (SWP) within processors 22 and 24 and signals for transferring the contents of fields of the instruction to other circuits within these processors.

CPU 10 includes an internal register file which, when executing multiple scalar instructions, is treated as two separate register files 34a and 34b, each containing 32 registers, each having 32 bits. This internal register file, when executing a vector instruction, is treated as 32 registers, each having 64 bits. Register file 34 has four 32-bit read and two write (4R/2W) ports. Physically, the register file is 64 bits wide, but it is split into two 32-bit files when processing scalar instructions.

When processing multiple scalar instructions, two 32-bit wide instructions may be issued in each clock cycle. Two 32-bit wide data may be read from register file 32 from left data path processor 22 and right data path processor 24, by way of multiplexers 30 and 32. Conversely, 32-bit wide data may be written to register file 32 from left data path processor 22 and right data path processor 24, by way of multiplexers 30 and 32. When processing one vector instruction, the left and right 32 bit register files and read/write ports are joined together to create a single 64-bit register file that has two 64-bit read ports and one write port (2R/1W).

CPU 10 includes a level-one local memory (LM) that is externally located of the core-processor and is split into two halves, namely left LM 26 and right LM 28. There is one clock latency to move data between processors 22, 24 and left and right LMs 26, 28. Like register file 34, LM 26 and 28 are each physically 64 bits wide.

It will be appreciated that in the 2i-SS programming model, as implemented in the Sparc architecture, two 32-bit wide instructions are consumed per clock. It may read and write to the local memory with a latency of one clock, which is done via load and store instructions, with the LM given an address in high memory. The 2i-SS model may also issue pre-fetching loads to the LM. The SPARC ISA has no instructions or operands for LM. Accordingly, the LM is treated as memory, and accessed by load and store instructions. When vector instructions are issued, on the other hand, their operands may come from either the LM or the register file (RF). Thus, up to two 64-bit data may be read from the register file, using both multiplexers (30 and 32) working in a coordinated manner. Moreover, one 64 bit datum may also be written back to the register file. One superscalar instruction to one datapath may move a maximum of 32 bits of data, either from the LM to the RF (a load instruction) or from the RF to the LM (a store instruction).

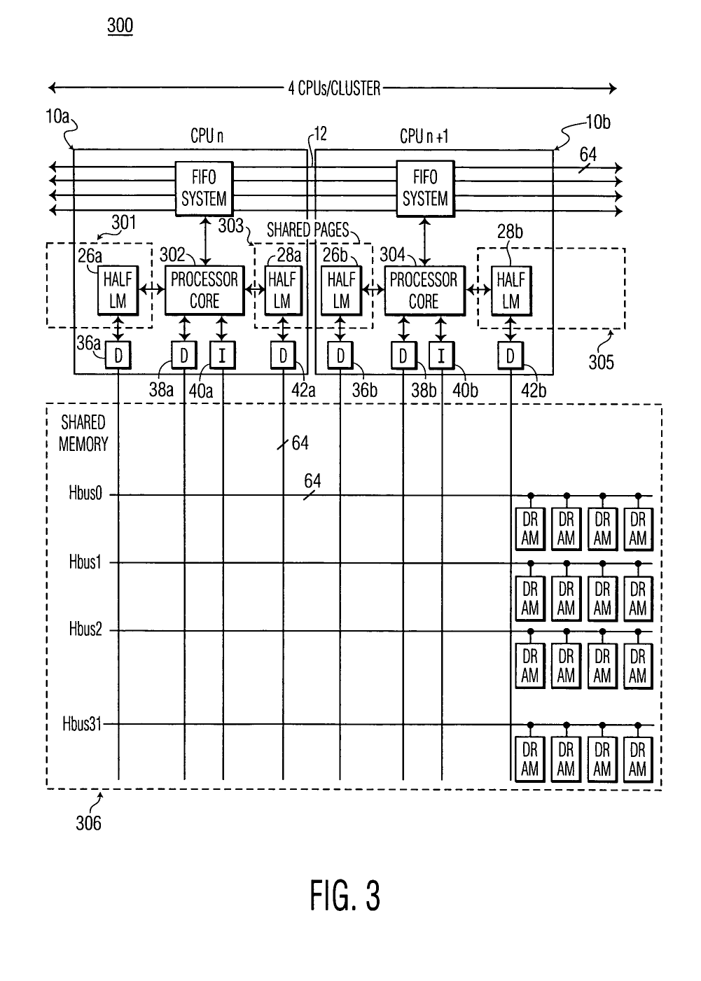

Four memory ports for accessing a level-two main memory of dynamic random access memory (DRAM) (as shown in FIG. 3) are included in CPU 10. Memory port 36 provides 64-bit data to or from left LM 26. Memory port 38 provides 64-bit data to or from register file 34, and memory port 42 provides data to or from right LM 28. 64-bit instruction data is provided to instruction cache 20 by way of memory port 40. Memory management unit (MMU) 44 controls loading and storing of data between each memory port and the DRAM. An optional level-one data cache, such as SPARC legacy data cache 46, may be accessed by CPU 10. In case of a cache miss, this cache is updated by way of memory port 38 which makes use of MMU 44.

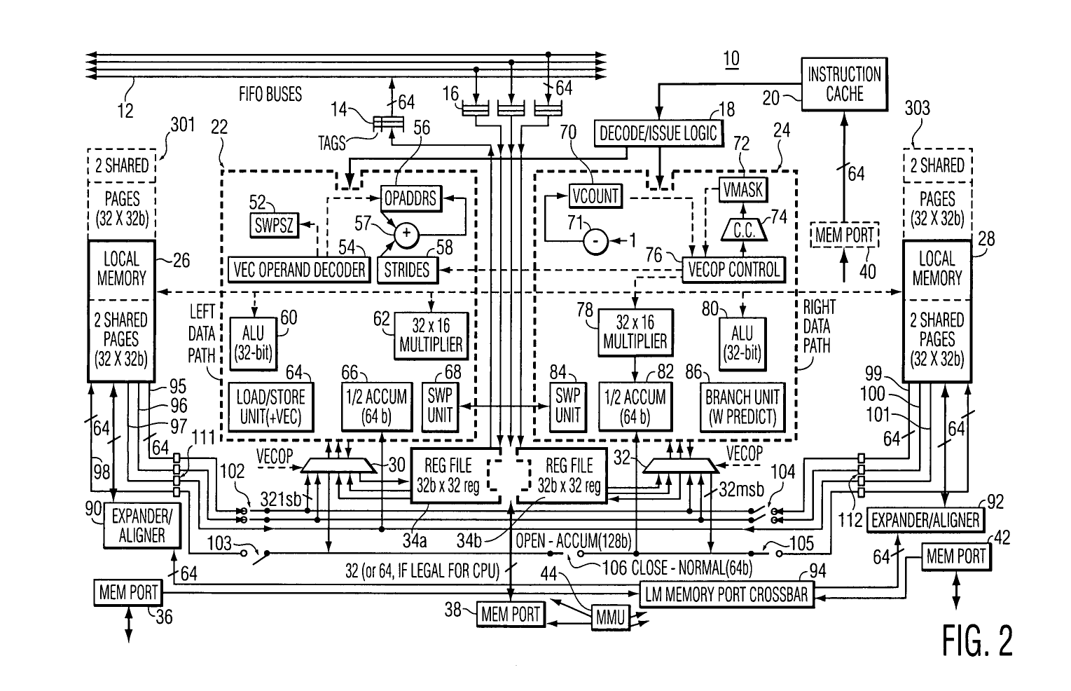

CPU 10 may issue two kinds of instructions: scalar and vector. Using instruction level parallelism (ILP), two independent scalar instructions may be issued to left data path processor 22 and right data path processor 24 by way of memory port 40. In scalar instructions, operands may be delivered from register file 34 and load/store instructions may move 32-bit data from/to the two LMs. In vector instructions, combinations of two separate instructions define a single vector instruction, which may be issued to both data paths under control of a vector control unit (as shown in FIG. 2). In vector instruction, operands may be delivered from the LMs and/or register file 34. Each scalar instruction processes 32 bits of data, whereas each vector instruction may process N×64 bits (where N is the vector length).

CPU 10 includes a first-in first-out (FIFO) buffer system having output buffer FIFO 14 and three input buffer FIFOs 16. The FIFO buffer system couples CPU 10 to neighboring CPUs (as shown in FIG. 3) of a multiprocessor system by way of multiple busses 12. The FIFO buffer system may be used to chain consecutive vector operands in a pipeline manner. The FIFO buffer system may transfer 32-bit or 64-bit instructions/operands from CPU 10 to its neighboring CPUs. The 32-bit or 64-bit data may be transferred by way of bus splitter 110.

Referring next to FIG. 2, CPU 10 is shown in greater detail. Left data path processor 22 includes arithmetic logic unit (ALU) 60, half multiplier 62, half accumulator 66 and sub-word processing (SWP) unit 68. Similarly, right data path processor 24 includes ALU 80, half multiplier 78, half accumulator 82 and SWP unit 84. ALU 60, 80 may each operate on 32 bits of data and half multiplier 62, 78 may each multiply 32 bits by 16 bits, or 2×16 bits by 16 bits. Half accumulator 66, 82 may each accumulate 64 bits of data and SWP unit 68, 84 may each process 8 bit, 16 bit or 32 bit quantities.

Non-symmetrical features in left and right data path processors include load/store unit 64 in left data path processor 22 and branch unit 86 in right data path processor 24. With a two-issue super scalar instruction, for example, provided from instruction decoder 18, the left data path processor includes instruction to the load/store unit for controlling read/write operations from/to memory, and the right data path processor includes instructions to the branch unit for branching with prediction. Accordingly, load/store instructions may be provided only to the left data path processor, and branch instructions may be provided only to the right data path processor.

For vector instructions, some processing activities are controlled in the left data path processor and some other processing activities are controlled in the right data path processor. As shown, left data path processor 22 includes vector operand decoder 54 for decoding source and destination addresses and storing the next memory addresses in operand address buffer 56. The current addresses in operand address buffer 56 are incremented by strides adder 57, which adds stride values stored in strides buffer 58 to the current addresses stored in operand address buffer 56.

It will be appreciated that vector data include vector elements stored in local memory at a predetermined address interval. This address interval is called a stride. Generally, there are various strides of vector data. If the stride of vector data is assumed to be “1”, then vector data elements are stored at consecutive storage addresses. If the stride is assumed to be “8”, then vector data elements are stored 8 locations apart (e.g. walking down a column of memory registers, instead of walking across a row of memory registers). The stride of vector data may take on other values, such as 2 or 4.

Vector operand decoder 54 also determines how to treat the 64 bits of data loaded from memory. The data may be treated as two-32 bit quantities, four-16 bit quantities or eight-8 bit quantities. The size of the data is stored in sub-word parallel size (SWPSZ) buffer 52.

The right data path processor includes vector operation (vecop) controller 76 for controlling each vector instruction. A condition code (CC) for each individual element of a vector is stored in cc buffer 74. A CC may include an overflow condition or a negative number condition, for example. The result of the CC may be placed in vector mask (Vmask) buffer 72.

It will be appreciated that vector processing reduces the frequency of branch instructions, since vector instructions themselves specify repetition of processing operations on different vector elements. For example, a single instruction may be processed up to 64 times (e.g. loop size of 64). The loop size of a vector instruction is stored in vector count (Vcount) buffer 70 and is automatically decremented by “1” via subtractor 71. Accordingly, one instruction may cause up to 64 individual vector element calculations and, when the Vcount buffer reaches a value of “0”, the vector instruction is completed. Each individual vector element calculation has its own CC.

It will also be appreciated that because of sub-word parallelism capability of CPU 10, as provided by SWPSZ buffer 52, one single vector instruction may process in parallel up to 8 sub-word data items of a 64 bit data item. Because the mask register contains only 64 entries, the maximum size of the vector is forced to create no more SWP elements than the 64 which may be handled by the mask register. It is possible to process, for example, up to 8×64 elements if the operation is not a CC operation, but then there may be potential for software-induced error. As a result, the invention limits the hardware to prevent such potential error.

Turning next to the internal register file and the external local memories, left data path processor 22 may load/store data from/to register file 34a and right data path processor 24 may load/store data from/to register file 34b, by way of multiplexers 30 and 32, respectively. Data may also be loaded/stored by each data path processor from/to LM 26 and LM 28, by way of multiplexers 30 and 32, respectively. During a vector instruction, two-64 bit source data may be loaded from LM 26 by way of busses 95, 96, when two source switches 102 are closed and two source switches 104 are opened. Each 64 bit source data may have its 32 least significant bits (LSB) loaded into left data path processor 22 and its 32 most significant bits (MSB) loaded into right data path processor 24. Similarly, two-64 bit source data may be loaded from LM 28 by way of busses 99, 100, when two source switches 104 are closed and two source switches 102 are opened.

Separate 64 bit source data may be loaded from LM 26 by way of bus 97 into half accumulators 66, 82 and, simultaneously, separate 64 bit source data may be loaded from LM 28 by way of bus 101 into half accumulators 66, 82. This provides the ability to preload a total of 128 bits into the two half accumulators.

Separate 64-bit destination data may be stored in LM 28 by way of bus 107, when destination switch 105 and normal/accumulate switch 106 are both closed and destination switch 103 is opened. The 32 LSB may be provided by left data path processor 22 and the 32 MSB may be provided by right data path processor 24. Similarly, separate 64-bit destination data may be stored in LM 26 by way of bus 98, when destination switch 103 and normal/accumulate switch 106 are both closed and destination switch 105 is opened. The load/store data from/to the LMs are buffered in left latches 111 and right latches 112, so that loading and storing may be performed in one clock cycle.

If normal/accumulate switch 106 is opened and destination switches 103 and 105 are both closed, 128 bits may be simultaneously written out from half accumulators 66, 82 in one clock cycle. 64 bits are written to LM 26 and the other 64 bits are simultaneously written to LM 28.

LM 26 may read/write 64 bit data from/to DRAM by way of LM memory port crossbar 94, which is coupled to memory port 36 and memory port 42. Similarly, LM 28 may read/write 64 bit data from/to DRAM. Register file 34 may access DRAM by way of memory port 38 and instruction cache 20 may access DRAM by way of memory port 40. MMU 44 controls memory ports 36, 38, 40 and 42.

Disposed between LM 26 and the DRAM is expander/aligner 90 and disposed between LM 28 and the DRAM is expander/aligner 92. Each expander/aligner may expand (duplicate) a word from DRAM and write it into an LM. For example, a word at address 3 of the DRAM may be duplicated and stored in LM addresses 0 and 1. In addition, each expander/aligner may take a word from the DRAM and properly align it in a LM. For example, the DRAM may deliver 64 bit items which are aligned to 64 bit boundaries. If a 32 bit item is desired to be delivered to the LM, the expander/aligner automatically aligns the delivered 32 bit item to 32 bit boundaries.

External LM 26 and LM 28 will now be described by referring to FIGS. 2 and 3. Each LM is physically disposed externally of and in between two CPUs in a multiprocessor system. As shown in FIG. 3, multiprocessor system 300 includes 4 CPUs per cluster (only two CPUs shown). CPUn is designated 10a and CPUn+1 is designated 10b. CPUn includes processor-core 302 and CPUn+1 includes processor-core 304. It will be appreciated that each processor-core includes a left data path processor (such as left data path processor 22) and a right data path processor (such as right data path processor 24).

A whole LM is disposed between two CPUs. For example, whole LM 301 is disposed between CPUn and CPUn−1 (not shown), whole LM 303 is disposed between CPUn and CPUn+1, and whole LM 305 is disposed between CPUn+1 and CPUn+2 (not shown). Each whole LM includes two half LMs. For example, whole LM 303 includes half LM 28a and half LM 26b. By partitioning the LMs in this manner, processor core 302 may load/store data from/to half LM 26a and half LM 28a. Similarly, processor core 304 may load/store data from/to half LM 26b and half LM 28b.

As shown in FIG. 2, whole LM 301 includes 4 pages, with each page having 32×32 bit registers. Processor core 302 (FIG. 3) may typically access half LM 26a on the left side of the core and half LM 28a on the right side of the core. Each half LM includes 2 pages. In this manner, processor core 302 and processor core 304 may each access a total of 4 pages of LM.

It will be appreciated, however, that if processor core 302 (for example) requires more than 4 pages of LM to execute a task, the operating system may assign to processor core 302 up to 4 pages of whole LM 301 on the left side and up to 4 pages of whole LM 303 on the right side. In this manner, CPUn may be assigned 8 pages of LM to execute a task, should the task so require.

Completing the description of FIG. 3, busses 12 of each FIFO system of CPUn and CPUn+1 corresponds to busses 12 shown in FIG. 2. Memory ports 36a, 38a, 40a and 42a of CPUn and memory ports 36b, 38b, 40b and 42b of CPUn+1 correspond, respectively, to memory ports 36, 38, 40 and 42 shown in FIG. 2. Each of these memory ports may access level-two memory 306 including a large crossbar, which may have, for example, 32 busses interfacing with a DRAM memory area. A DRAM page may be, for example, 32 K Bytes and there may be, for example, up to 128 pages per 4 CPUs in multiprocessor 300. The DRAM may include buffers plus sense-amplifiers to allow a next fetch operation to overlap a current read operation.

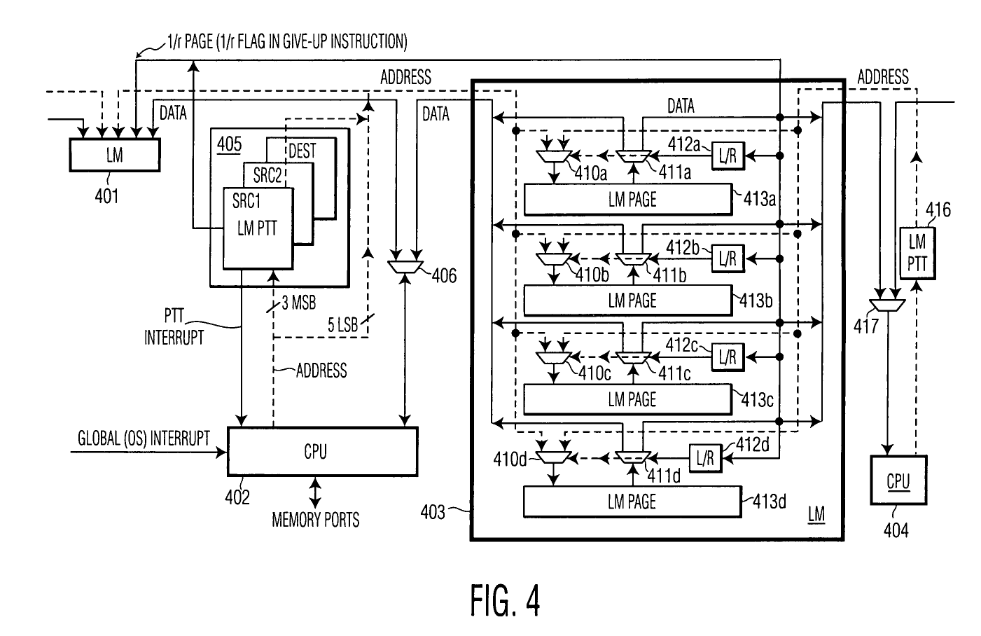

Referring next to FIG. 4, there is shown multiprocessor system 400 including CPU 402 accessing LM 401 and LM 403. It will be appreciated that LM 403 may be cooperatively shared by CPU 402 and CPU 404. Similarly, LM 401 may be shared by CPU 402 and another CPU (not shown). In a similar manner, CPU 404 may access LM 403 on its left side and another LM (not shown) on its right side.

LM 403 includes pages 413a, 413b, 413c and 413d. Page 413a may be accessed by CPU 402 and CPU 404 via address multiplexer 410a, based on left/right (L/R) flag 412a issued by LM page translation table (PTT) control logic 405. Data from page 413a may be output via data multiplexer 411a, also controlled by L/R flag 412a. Page 413b may be accessed by CPU 402 and CPU 404 via address multiplexer 410b, based on left/right (L/R) flag 412b issued by the PTT control logic. Data from page 413b may be output via data multiplexer 411b, also controlled by L/R flag 412b. Similarly, page 413c may be accessed by CPU 402 and CPU 404 via address multiplexer 410c, based on left/right (L/R) flag 412c issued by the PTT control logic. Data from page 413c may be output via data multiplexer 411c, also controlled by L/R flag 412c. Finally, page 413d may be accessed by CPU 402 and CPU 404 via address multiplexer 410d, based on left/right (L/R) flag 412d issued by the PTT control logic. Data from page 413d may be output via data multiplexer 411d, also controlled by L/R flag 412d. Although not shown, it will be appreciated that the LM control logic may issue four additional L/R flags to LM 401.

CPU 402 may receive data from a register in LM 403 or a register in LM 401 by way of data multiplexer 406. As shown, LM 403 may include, for example, 4 pages, where each page may include 32×32 bit registers (for example). CPU 402 may access the data by way of an 8-bit address line, for example, in which the 5 least significant bits (LSB) bypass LM PTT control logic 405 and the 3 most significant bits (MSB) are sent to the LM PTT control logic.

It will be appreciated that CPU 404 includes LM PTT control logic 416 which is similar to LM PTT control logic 405, and data multiplexer 417 which is similar to data multiplexer 406. Furthermore, as will be explained, each LM PTT control logic includes three identical PTTs, so that each CPU may simultaneously access two source operands (SRC1, SRC2) and one destination operand (dest) in the two LMs (one on the left and one on the right of the CPU) with a single instruction.

Moreover, the PTTs make the LM page numbers virtual, thereby simplifying the task of the compiler and the OS in finding suitable LM pages to assign to potentially multiple tasks assigned to a single CPU. As the OS assigns tasks to the various CPUs, the OS also assigns to each CPU only the amount of LM pages needed for a task. To simplify control of this assignment, the LM is divided into pages, each page containing 32×32 bit registers.

An LM page may only be owned by one CPU at a time (by controlling the setting of the L/R flag from the PTT control logic), but the pages do not behave like a conventional shared memory. In the conventional shared memory, the memory is a global resource, and processors compete for access to it. In this invention, however, the LM is architected directly into both processors (CPUs) and both are capable of owning the LM at different times. By making all LM registers architecturally visible to both processors (one on the left and one on the right), the compiler is presented with a physically unchanging target, instead of a machine whose local memory size varies from task to task.

A compiled binary may require an amount of LM. It assumes that enough LM pages have been assigned to the application to satisfy the binary's requirements, and that those pages start at page zero and are contiguous. These assumptions allow the compiler to produce a binary whose only constraint is that a sufficient number of pages are made available; the location of these pages does not matter. In actuality, however, the pages available to a given CPU depend upon which pages have already been assigned to the left and right neighbor CPUs. In order to abstract away which pages are available, the page translation table is implemented by the invention (i.e., the LM page numbers are virtual.)

An abstraction of a LM PTT is shown below.

| Logical | | Physical |
|---|---|---|
| Page | Valid? | Page |
| 0 | Y | 0 |
| 1 | Y | 5 |
| 2 | N | (6) |
| 3 | Y | 4 |

As shown in the table, each entry has a protection bit, namely a valid (or accessible) bit. If the bit is set, the translation is valid (page is accessible); otherwise, a fatal error is generated (i.e., a task is erroneously attempting to write to an LM page not assigned to that task). The protection bits are set by the OS at task start time. Only the OS may set the protection bits.

In addition to the protection bits (valid/not valid) (accessible/not accessible) provided in each LM PTT, each physical page of a LM has an owner flag associated with it, indicating whether its current owner is the CPU to its right or to its left. The initial owner flag is set by the OS at task start time. If neither neighbor CPU has a valid translation for a physical page, that page may not be accessed; so the value of its owner bit is moot. If a valid request to access a page comes from a CPU, and the requesting CPU is the current owner, the access proceeds. If the request is valid, but the CPU is not the current owner, then the requesting CPU stalls until the current owner issues a giveup page command for that page. Giveup commands, which may be issued by a user program, toggle the ownership of a page to the opposite processor. Giveup commands are used by the present invention for changing page ownership during a task. Attempting to giveup an invalid (or not accessible) (protected) page is a fatal error.

When a page may be owned by both adjacent processors, it is used cooperatively, not competitively by the invention. There is no arbitration for control. Cooperative ownership of the invention advantageously facilitates double-buffered page transfers and pipelining (but not chaining) of vector registers, and minimizes the amount of explicit signaling. It will be appreciated that, unlike the present invention, conventional multiprocessing systems incorporate writes to remote register files. But, remote writes do not reconfigure the conventional processor's architecture; they merely provide a communications pathway, or a mailbox. The present invention is different from mailbox communications.

At task end time, all pages and all CPUs, used by the task, are returned to the pool of available resources. For two separate tasks to share a page of a LM, the OS must make the initial connection. The OS starts the first task, and makes a page valid (accessible) and owned by the first CPU. Later, the OS starts the second task and makes the same page valid (accessible) to the second CPU. In order to do this, the two tasks have to communicate their need to share a page to the OS. To prevent premature inter-task giveups, it may be necessary for the first task to receive a signal from the OS indicating that the second task has started.

In an exemplary embodiment, a LM PTT entry includes a physical page location (1 page out of possible 8 pages) corresponding to a logical page location, and a corresponding valid/not valid protection bit (Y/N), both provided by the OS. Bits of the LM PTT, for example, may be physically stored in ancillary state registers (ASR's) which the Scalable Processor Architecture (SPARC) allows to be implementation dependent. SPARC is a CPU instruction set architecture (ISA), derived from a reduced instruction set computer (RISC) lineage. SPARC provides special instructions to read and write ASRs, namely rdasr and wrasr.

According to the an embodiment of the architecture, if the physical register is implemented to be only accessible by a privileged user, then a rd/wrasr instruction for that register also requires a privileged user. Therefore, in this embodiment, the PTTs are implemented as privileged write-only registers (write-only from the point of view of the OS). Once written, however, these registers may be read by the LM PTT control logic whenever a reference is made to a LM page by an executing instruction.

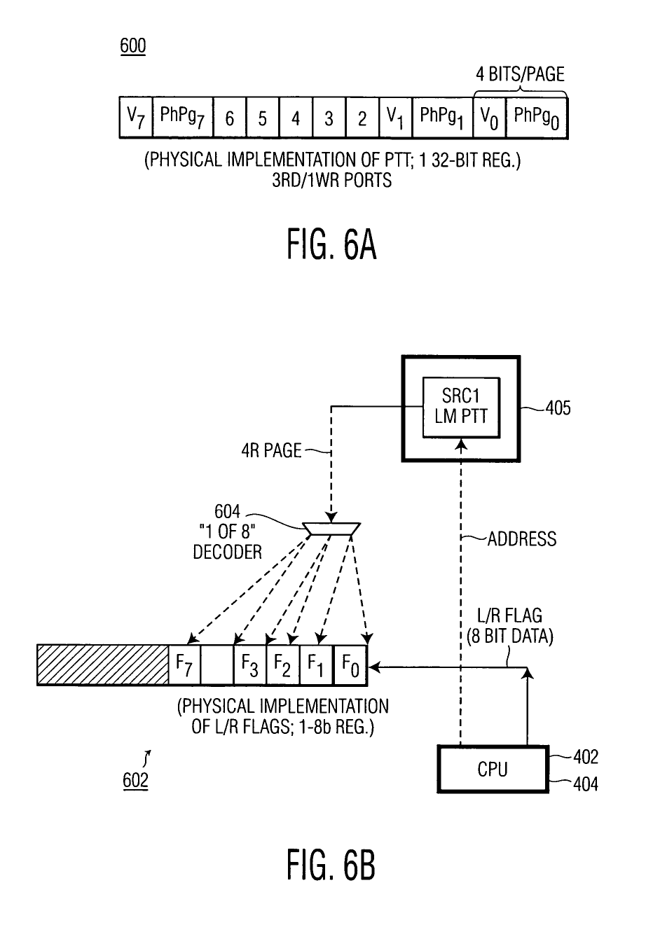

Referring next to FIG. 6A, there is shown one embodiment of a physical implementation of a LM PTT, generally designated as 600 (An abstraction of the PTT is discussed before). As shown, LM PTT 600 may be implemented in one 32 bit register. Four bits are allocated for each page of a LM, thus including 32 bits per 8 pages of the LM. Accordingly, page 0 includes a validity bit (Vo) and a physical page 0 (PhPgo) of 3 bits. The other seven pages have similar four bit fields. As shown, the PTT register is implemented to physically include three read ports and one write port, so that two source operands and one destination operand may be accessed concurrently (this physical implementation of a PTT corresponds to the three identical PTTs discussed before as an abstraction).

The LM PTT may be physically implemented in one of the privileged ASR registers (ASR 8, for example) and written to only by the OS. Once written, a CPU may access a LM via the three read ports of the LM register.

It will be appreciated that the LM PTT of the invention is similar to a page descriptor cache or a translation lookaside buffer (TLB). A conventional TLB, however, has a potential to miss (i.e., an event in which a legal virtual page address is not currently resident in the TLB). In a miss circumstance, the TLB must halt the CPU (by a page fault interrupt), run an expensive miss processing routine that looks up the missing page address in global memory, and then write the missing page address into the TLB. The LM PTT of the invention, on the other hand, only has a small number of pages (e.g. 8) and, therefore, advantageously all pages may reside in the PTT. After the OS loads the PTT, it is highly unlikely for a task not to find a legal page translation. The invention, thus, has no need for expensive miss processing hardware, which is often built into the TLB.

Furthermore, the left/right task owners of a single LM page are similar to multiple contexts in virtual memory. Each LM physical page has a maximum of two legal translations: to the virtual page of its left-hand CPU or to the virtual page of its right hand CPU. Each translation may be stored in the respective PTT. Once again, all possible contexts may be kept in the PTT, so multiple contexts (more than one task accessing the same page) cannot overflow the size of the PTT.

Referring next to FIG. 6B, there is shown one embodiment of a physical implementation of the L/R flags (four flags out of a possible eight flags are shown in FIG. 4 as L/R flags 412a-d controlling multiplexers 410a-d and 411 a-d, respectively). As shown, CPU 402, 404 (for example) initially sets 8 bits (corresponding to 8 pages per CPU) denoting L/R ownership of LM pages. The L/R flags may be written into non-privileged register 602. It will be appreciated that in the SPARC ISA a non-privileged register may be, for example ASR 9.

In operation, the OS handler reads the new L/R flags and sets them in non privileged register 602. A task which currently owns a LM page may issue a giveup command. The giveup command specifies which page's ownership is to be transferred, so that the L/R flag may be toggled (for example, L/R flag 412a-d).

As shown, the page number of the giveup is passed through src1 in LM PTT control logic 405 which, in turn, outputs a physical page. The physical page causes the 1 of 8 decoder (604) to write the page ownership (coming from the CPU as an operand of the giveup instruction) to the bit of non-privileged register 602 corresponding to the decoded physical page. There is no OS intervention for the page transfer. This makes the transfer very fast, without system calls or arbitration.

It will be understood that CPU 402, 404 may write 8 bits to non-privileged register 602 in order to initialize the L/R flags. The giveup command sends 1 bit through decoder 604 (without OS intervention) to toggle a L/R flag in register 602.

Returning to the LM PTT control logic of FIG. 4, a PTT interrupt signal may be transmitted from control logic 405 to CPU 402. The PTT interrupt may include a fatal error trap and a page fault trap. If a task tries to access an illegal LM page (validity bit=NO), PTT control logic 405 may generate a fatal error trap to accessing CPU 402. If a task tries to access a legal, but currently not owned LM page, PTT control logic 405 may generate a page fault trap to accessing CPU 402. If CPU 402 is capable of multi-tasking, it may decide to run a different task, while waiting for the page fault to resolve. If not capable of multi-tasking, the CPU may simply wait for the fault to resolve.

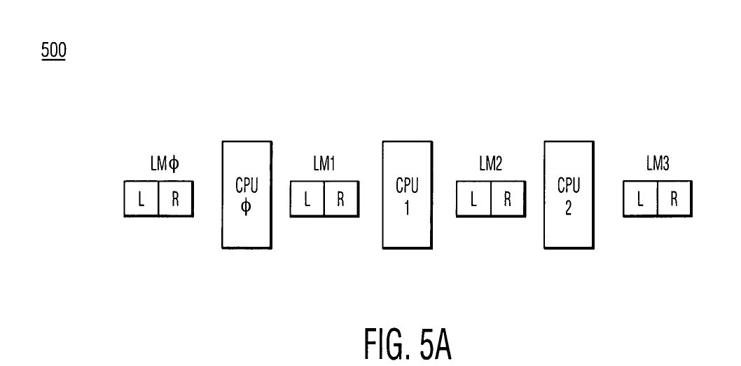

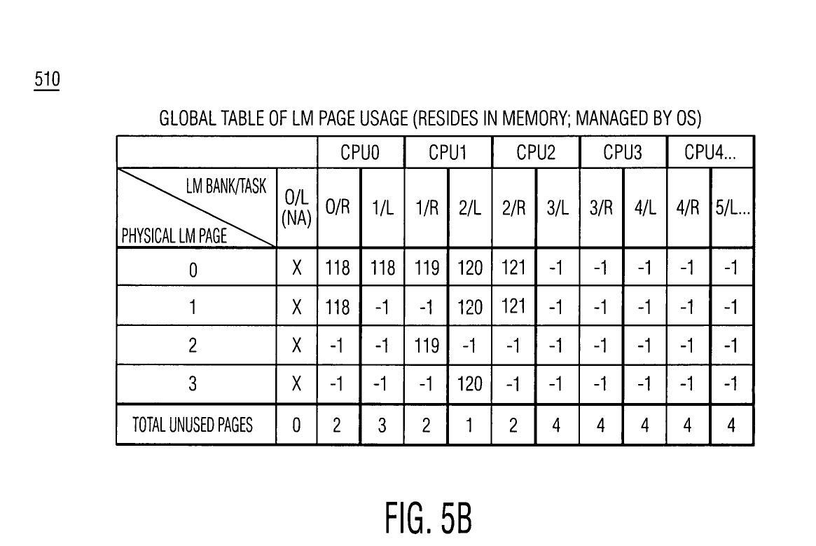

The manner in which the OS assigns left/right LM pages to each cooperating CPU will now be discussed. Referring first to FIG. 5A, there is shown multiprocessing system 500 including CPU 0, CPU 1 and CPU 2 (for example). Four banks of LMs are included, namely LM0, LM1, LM2 and LM3. Each LM is physically interposed between two CPUs and, as shown, is designated as belonging to a left CPU and/or a right CPU. For example, the LM1 bank is split into left (L) LM and right (R) LM, where left LM is to the right of CPU 0 and right LM is to the left of CPU 1. The other LM banks are similarly designated.

In an embodiment of the invention, the compiler determines the number of left/right LM pages (up to 4 pages) needed by each CPU in order to execute a respective task. The OS, responsive to the compiler, searches its main memory (DRAM, for example) for a global table of LM page usage to determine which LM pages are unused. The OS then reserves a contiguous group of CPUs to execute the respective tasks and also reserves LM pages for each of the respective tasks. The OS performs the reservation by writing the task number for the OS process in selected LM pages of the global table.

An exemplary global table showing LM page usage is illustrated in FIG. 5B and is generally designated as 510. The global table resides in main memory and is managed by the OS. As shown in the table, CPU 0 includes LM bank 0/right and LM bank 1/left (note correspondence with FIG. 5A). Similarly, CPU 1 includes LM bank 1/right and LM bank 2/left, and so on.

In the example of FIG. 5B, CPU 0 is assigned to run task 118, which uses 3 LM pages (2 on left of CPU 0 and 1 on right of CPU 0). CPU 1 is assigned to run task 119, which uses 2 LM pages (2 on left of CPU 1), and assigned task 120, which uses 3 LM pages (3 on right of CPU 1). Finally, CPU 2 is assigned to run task 121, which uses 2 LM pages (2 on left of CPU 2). CPU 3 and CPU 4 have no tasks assigned to them (indicated by −1).

Although only 4 CPUs are shown in global table 510, it will be appreciated that the invention may include a multiprocessing system having more than 4 CPUs, and the OS may, therefore, similarly manage all CPUs. It will also be appreciated that since CPU 0 is the first CPU, LM bank 0/left does not exist (pages are designated with Xs).

Still referring to FIG. 5B, task 118 of CPU 0 cooperates with task 119 of CPU 1 by using the same shared physical page 0 of LM bank 1. Task 120 of CPU 1 cooperates with task 121 of CPU 2 via shared physical pages 0 and 1 of LM bank 2.

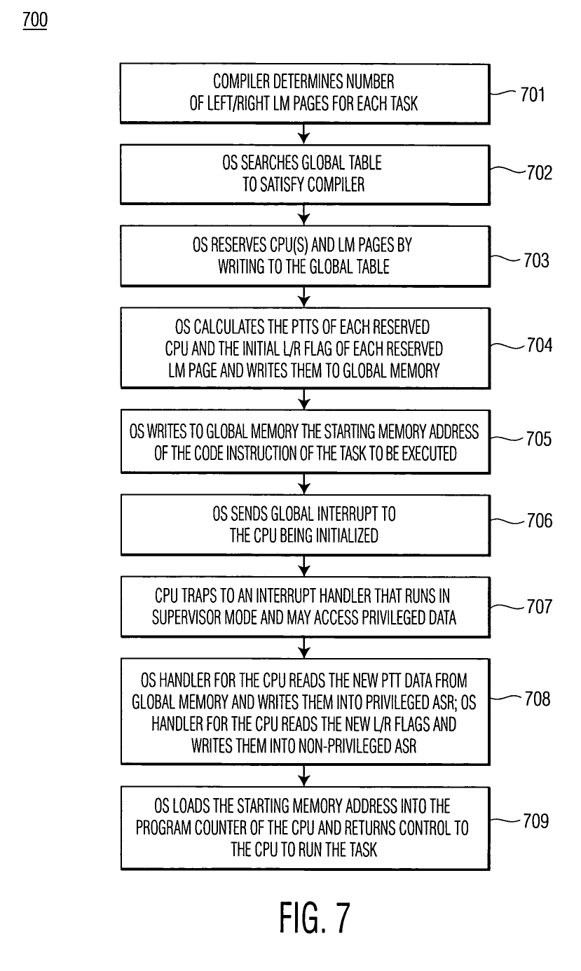

The manner in which the OS sets up a task for each CPU in a multiprocessing system will now be discussed by referring to FIG. 7. An exemplary embodiment of an OS method for setting up a task, generally designated as 700, begins in step 701, with the compiler determining the number of left/right LM pages needed for each cooperating task. The programmer may be allowed to include compiler directives or pragmas in the instruction code. These directives may force the compiler to use a specific number and location of LM pages.

The OS, responsive to the compiler, determines that a CPU, or a set of CPUs have sufficient available LM resources for a task. In step 702, the OS searches its global table of LM page usage in memory and checks for unused LM pages that are contiguous to a group of CPUs satisfying the requirements of the compiler. In step 703, the OS reserves one or more CPUs and LM pages for the task. The OS writes the task number into the selected LM pages of the global table (FIG. 5B). The OS keeps a record of LM physical page assignments in the global table, so that it may calculate which LM pages are free.

The OS calculates, in step 704, the PTT data fields of each reserved CPU and the initial L/R flag of each CPU. The OS writes these into global memory. The OS also writes into global memory, in step 705, the starting memory address of the task's instruction code.

In step 706, the OS sends a global interrupt to the CPU being initialized to execute a task (for example, global interrupt to CPU 402 in FIG. 4). The CPU traps, in step 707, to an interrupt handler (software) for OS interrupts, branches to the global memory that has the stored initialization data, and reads the new PTT data. This interrupt handler runs in a supervisor mode, and is allowed to access privileged data.

The OS handler, in step 708, reads the new PTT data from global memory and writes the PTT data into a privileged register. Such privileged register may include the PTT data shown in FIG. 6A, containing a validity bit and a physical page number for each LM page. The OS handler also reads the new L/R flags associated with each LM page and writes the L/R flags into a non-privileged register (FIG. 6B).

It will be appreciated that the OS handler writes the initial state of the L/R flag for a LM page into a non-privileged register (FIG. 6B), since non-privileged tasks running on the CPU must be able to issue a giveup command to this register. It will further be appreciated that in the SPARC ISA the OS may use a wrasr privileged command to load the other data fields (FIG. 6A) into a privileged ASR. At this stage of the method, the PTT for the CPU may be considered to be initialized.

In step 709, the OS starts the task by loading the program counter of the CPU with an address of the beginning of an instruction code segment for that task. This causes the CPU to start running the task.

It will be understood that the method shown in FIG. 7 may be applied by the OS to each task assigned to a respective CPU in the multiprocessing system. For example, task (1) may be assigned to CPU (1) and task (2) may be assigned to CPU (2). The OS may first initialize CPU (1) to run task (1) and then initialize CPU (2) to run task (2). Alternatively, the OS may initialize both CPU (1) and CPU (2), so that task (1) and task (2) may be executed concurrently.

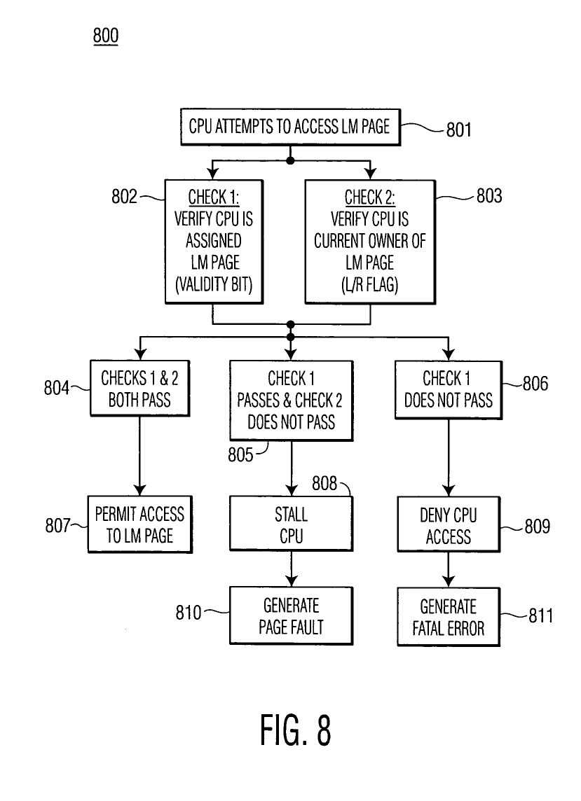

Having been initialized, a CPU may read or write data to a LM page, based on the data fields stored in PTT register 600 and the corresponding L/R flags stored in the non-privileged register 602. Referring next to FIG. 8, there is shown a method, in accordance with an embodiment of the invention, for granting or denying access by a CPU to a LM page. The method, generally designated as 800, begins in step 801 when a CPU of a multiprocessing system attempts to access a LM page. The method, via the PTT control logic, performs two checks in steps 802 and 803. The first check verifies that the CPU attempting access to the LM page is assigned to that LM page. This is accomplished by reading the corresponding validity bit stored in the privileged PTT register. The second check verifies that the same CPU is the current owner of that LM page. This is accomplished by reading the corresponding L/R flag stored in the non-privileged register.

If the LM page is valid and is currently owned by the CPU (as determined in step 804), the CPU is permitted to access the LM page (step 807). If, on the other hand, the first check passes and the second check does not pass (as determined in step 805), the CPU is stalled (step 808) and a page fault is generated (step 810) by the PTT control logic.

Furthermore, if check 1 does not pass, regardless of the result of check 2 (as determined in step 806), the CPU is denied access to the LM page (step 809) and a fatal error is generated (step 811) by the PTT control logic.

If a non-owning CPU attempts to access a valid LM page it does not currently own, the CPU stalls until it acquires ownership (as described below). The stall is generated by the PTT control logic. A CPU that is not initially the owner of a specific LM page may run its instruction code, without interference, so long as it does not attempt to access that specific page. As soon as the CPU tries to access a valid page it does not own, however, it stalls. The CPU stalls until it acquires ownership (after the L/R flag is toggled by a task of the other CPU).

If a CPU attempts to access a LM page not assigned to its task(s), however, that is a fatal error for that task. This fatal error is signaled to the OS by the PTT control logic, which detects that a page translation tried to access an invalid page.

Cooperating tasks may transfer ownership of a LM page many times throughout the course of task execution. No OS intervention is necessary. At some point in the instruction code, a giveup command is issued, in accordance with an embodiment of the invention. This command implies that the current CPU is no longer the owner of a LM page. Ownership of that LM page is given to the other CPU that shares the LM page. It will be appreciated that two adjacent CPUs share a group of LM pages that is physically disposed between them. This transfer of ownership is accomplished by toggling the L/R flag for that LM page. The giveup command is a non-privileged wrasr command in the SPARC ISA for toggling the flag.

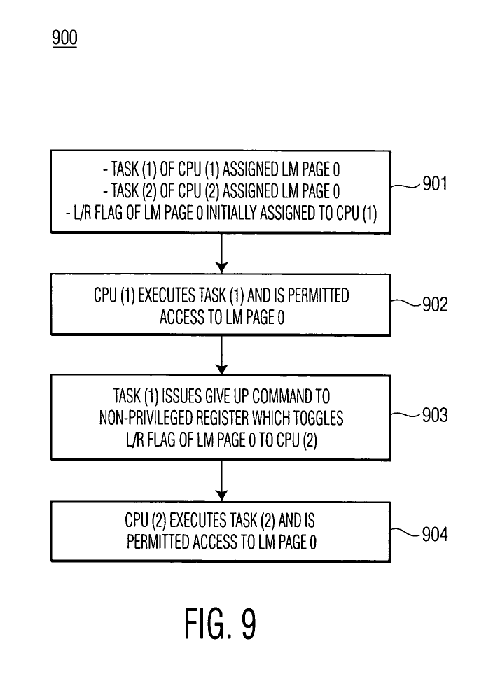

Referring now to FIG. 9, there is shown method 900 for transferring ownership of a LM page between cooperating tasks, in accordance with an embodiment of the invention. As shown, step 901, via the OS, initializes CPU (1) and CPU (2), as described before. Task (1) and task (2) are both assigned a valid LM page 0, with ownership granted initially to CPU (1) (for example). CPU (1) executes task (1) and may access LM page 0 (step 902).

Task (1), which currently owns LM page 0, issues a giveup command specifying that the ownership of LM page 0 is to be transferred (step 903). This command toggles the L/R flag of LM page 0 in the non-privileged register. CPU (2) is now the current owner of LM page 0. CPU (2) executes task (2) and is permitted access to LM page 0 (step 904).

As discussed before, there is no OS intervention for a legal LM page transfer. This advantageously makes the transfer very fast, as no system call or arbitration is required.

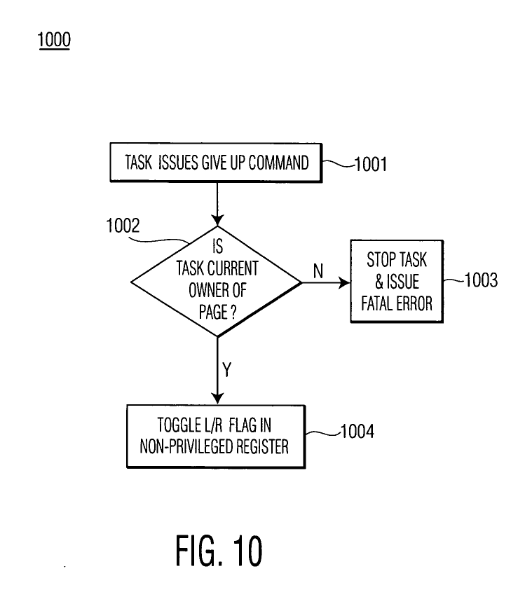

If the giveup command attempts to toggle a page it does not have permission to own, a fatal error occurs. If the giveup command attempts to toggle a page it has permission to own, but does not currently own, a fatal error occurs. This fatal error is signaled to the OS by the LM PTT control logic, which detects an illegal attempt to toggle the L/R flag. This is illustrated in an exemplary method, generally designated as 1000, as shown in FIG. 10. As shown, a task issues a giveup command (step 1001). The method, in decision box 1002, determines whether the task is the current owner of the page. If it is the current owner, the method branches to step 1004 and toggles the L/R flag in the non-privileged register. If it is not the current owner, the method branches to step 1003 and issues a fatal error.

Although illustrated and described herein with reference to certain specific embodiments, the present invention is nevertheless not intended to be limited to the details shown. Rather, various modifications may be made in the details within the scope and range of equivalents of the claims without departing from the spirit of the invention.

What is claimed:

1. A multiprocessor system for concurrently executing multiple tasks comprising
first and second processors each configured to execute at least one task,
a local memory physically disposed externally of, and concurrently accessible by, the first and second processors,
an operating system, responsive to task instructions, for assigning
(a) a first task to the first processor and a second task to the second processor, the first and second tasks having respective execution resource requirements,
(b) a first portion of the local memory to the first processor, and
(c) a second portion of the local memory to the second processor, and
the operating system configured to initially adjust the first and second portions of the external local memory based on the respective execution resource requirements.

2. The multiprocessor system of claim 1 wherein the first and second processors each includes at least one page translation table (PTT) for granting or preventing access to the first and second portions of the local memory.

3. The multiprocessor system of claim 2 wherein the at least one PTT includes
a physical location in the local memory, the physical location corresponding to a virtual location provided by a task instruction, and
a protection bit for granting or preventing access to the physical location.

4. The multiprocessor system of claim 2 wherein the first and second processors each includes multiple PTTs for concurrently granting access to two source operands and a destination operand located in the local memory.

5. The multiprocessor system of claim 1 including owner flags stored in a register, the owner flags initially assigned by the operating system to the first and second portions of the local memory,
wherein a first owner flag initially grants ownership of the first portion of the local memory to the first processor and a second owner flag initially grants ownership of the second portion of the local memory to the second processor.

6. The multiprocessor system of claim 5 wherein the first owner flag grants ownership of the first portion of the local memory to the first processor at execution startup of the first task.

7. The multiprocessor system of claim 6 in which the first processor includes a giveup page command for toggling the first owner flag in the register,
wherein the giveup page command gives up ownership of the first portion of the local memory to the first processor and grants ownership of the first portion of the local memory to the second processor.

8. The multiprocessor system of claim 1 wherein the local memory includes multiple pages, each of the pages having a plurality of registers, and
the first and second portions of the local memory each includes one of zero, one, two, three and four pages.

9. The multiprocessor system of claim 1 wherein the local memory is physically disposed at substantially equal distances between the first and second processors, and
the local memory is concurrently accessible by the first and second processors in a single execution cycle.

10. The multiprocessor system of claim 1 wherein each of the first and second processors includes a left data path processor and a right data path processor for executing task instructions.

11. In a multiprocessor system including a compiler, an operating system, first and second processors for executing first and second tasks, respectively, and a local memory having pages physically disposed externally of the processors,
a method of assigning at least one page of the external local memory to at least one of the processors comprising the steps of:
(a) determining a number of pages of the external local memory used to execute each of the first and second tasks;
(b) assigning, initially, a common page of the local memory to the first and second processors;
(c) assigning, initially, ownership of the common page to the first processor;
(d) accessing the common page during execution of the first task;
(e) giving up ownership of the common page, after completion of the first task by the first processor; and
(f) granting ownership of the common page, directly to the second processor, free-of intervention from the operating system.

12. The method of claim 11 in which
step (b) includes writing to a page translation table (PTT) of each of the first and second processors, a physical location of the common page, and a validity bit indicating the common page is accessible by both the first and second processors.

13. The method of claim 11 in which
step (c) includes setting an owner flag for initially granting exclusive ownership of the common page to the first processor.

14. The method of claim 13 in which the owner flag is set at execution startup of the first task.

15. The method of claim 13 in which
step (e) includes issuing a giveup page command for toggling ownership of the common page from the first processor to the second processor.

16. The method of claim 11 in which
accessing by the first processor includes concurrently accessing two source operands and a destination operand located in the common page by a single task instruction.

17. The method of claim 16 in which accessing the common page by the first processor includes accessing the operands in a single clock cycle.

18. In a multiprocessor system including a scalable processor architecture (SPARC), and first and second processors concurrently executing a SPARC instruction set,
a method of accessing a local memory, in which the local memory is externally located between the first and second processors, the method comprising the steps of:
(a) assigning, by an operating system, a first task to the first processor and a second task to the second processor;
(b) assigning, by the operating system, a first portion of the externally located local memory to the first processor, based on execution resource requirements for executing the first task; and
(c) preventing, by the operating system, access by the second processor to the first portion of the externally located local memory assigned to the first processor.

19. The method of claim 18 in which step (b) includes writing in an ancillary state register (ASR) a physical location of the first portion of the local memory, and
writing, in the ASR, a validity bit, corresponding to the physical location of the first portion of the local memory for allowing access by the first processor.

20. The method of claim 18 in which step (c) includes writing in a different ASR an owner flag granting ownership to the first processor of the first portion of the local memory.

21. The method of claim 20 including the steps of:
(d) giving up ownership of the first portion of the local memory by the first processor, free-of intervention from the operating system; and
(e) allowing access from the second processor to the first portion of the local memory, after giving up ownership in step (d), free-of intervention from the operating system.

22. The method of claim 18 including the step of:
(d) assigning, by the operating system a third portion of a first internal memory to the first processor and a fourth portion of a second internal memory to the second processor, wherein the first and second internal memories are located internally within both the first and second processors.
